(19) United States
(12) Patent Application Publication
(10) Pub. No.: US 2004/0203604 A1
(43) Pub. Date: Oct. 14, 2004

(54) Automatic keyboard unlock for mobile telephones based on multiple key entries

(75) Inventor: Pierluigi Pugliese, Vaterstetten (DE)

Correspondence Address: HITT GAINES P.C., P.O. BOX 832570, RICHARDSON, TX, 75083, US

(73) Assignee: Agere Systems Inc., Allentown, PA

(21) Appl. No.: 10/379,475

(22) Filed: Mar. 4, 2003

(30) Foreign Application Priority Data
Mar. 25, 2002 (EP) 2006818.5

(51) Int. Cl. H04M 1/68; H04M 1/66

(52) U.S. Cl. 455/411; 455/418; 455/575.1

(57) ABSTRACT

An electronic device including a keyboard having a plurality of keys with the keyboard having a key lock function that, when activated, locks the keyboard against unintended input operations. The keyboard is apt to be unlocked and at least a portion is unlocked by entering a sequence of intentional key entries. The sequence of intentional key entries allows the keyboard to be unlocked and preferably entering additional keys or operations.

### CROSS-REFERENCE TO FOREIGN APPLICATION

This application claims the benefit of EPC Patent Application No. 02006818.5 entitled “Automatic Keyboard Unlock for Mobile Phones Based on Multiple Key Entries” to Pierluigi Pugliese, filed on Mar. 25, 2002, which is incorporated herein by reference.

### TECHNICAL FIELD OF THE INVENTION

The present invention is directed, in general, to electronic devices and, more specifically, to electronic devices having a keyboard with a key lock function that, when activated, locks the keyboard against any unintended input operation and to mobile telephones having such keyboard functionality.

### BACKGROUND OF THE INVENTION

Unintended key entries on a mobile telephone may result in establishing a telephone call. Due to costs that may be involved with the telephone call, it is often necessary and important to protect users of mobile telephones against such key entries. Existing mobile telephones may have different types of key lock functions to prevent any unintended input operations such as unintended key entries.

For example, a Nokia series 6110 mobile telephone requires a double key entry to lock and unlock the keyboard. The double key entry includes pressing a first key and then, after a very short period of time, pressing a second key located at an opposite side of the keyboard. Some users may find the timing and logistics of pressing the proper keys frustrating and difficult. Elderly people may especially experience difficulties in meeting the temporal requirements to successfully unlock the keyboard.

A Siemens C 35 and S 35 mobile telephone have keyboards that are locked and unlocked by an extra long key press of a special key on the keyboard. Such an extra long key entry and pressing of the special key, however, requires additional attention and extra time. Thus, users may also find this locking and unlocking requirement frustrating.

Accordingly, what is needed in the art is an electronic device that provides a safe and reliable keyboard lock functionality, but does not necessarily entail special attention or a special procedure for unlocking the keyboard.

### SUMMARY OF THE INVENTION

To address the above-discussed deficiencies of the prior art, the present invention provides an electronic device including a keyboard with a plurality of keys. In one embodiment, the keyboard of the electronic device has a key lock function that, when activated, locks the keyboard against unintended input operations. Additionally, the keyboard is apt to be unlocked and at least a portion is unlocked by entering a sequence of intentional key entries.

The present invention, therefore, introduces the broad concept of an electronic device having a keyboard that may require no special attention or action by a user to unlock the keyboard. More specifically, an electronic device is presented that preferably does not require additional key presses or time for locking and unlocking of the keyboard.

The electronic device associated with the present invention may not require special attention or key presses for locking and unlocking the keyboard since the keyboard may be unlocked by entering a sequence of intentional key entries. The intentional key entries may be usual user key entries, for example, such as a telephone number. An intentional key entry may be decided by detecting how long a key is pressed and released when entered. The keyboard may be unlocked upon deciding that a key entry was an intentional key entry.

Typically, unintended key entries will have a different temporal behavior as an intended key entry. For example, key entries due to strokes or an article placed on the mobile telephone will typically be pressed and released for a different amount of time verses an intentional entry. Accordingly, an acceptable degree of likelihood in determining whether an intended or an unintended key entry was made may be achieved when considering even a single key entry.

In a preferred embodiment, a plurality of key entries may be employed to unlock the keyboard. In addition to a first key entry being made within a predefined interval of time, a determination is also made whether a certain number of further key entries are made within respective predefined time limits. A decision is made to unlock the keyboard if a defined number of entries are made within the respective predefined time limits. The defined number of entries may increase the likelihood of deciding between intentional and unintentional key entries.

In another preferred embodiment, pressing and releasing times of a number of key entries may be employed to unlock the keyboard. The electronic device may store pressing and releasing times of a number of key entries during a certain interval of time and accept the number of key entries as valid input operations if the time limits for pressing and releasing are met. Additionally, the electronic device may disregard the number of key entries if the time limits for pressing and releasing are not met. The multiply key entries may provide a fail safe operation without requiring additional key entries.

Furthermore, additional safety in deciding if a key entry was an intentional entry may be increased by also requesting a key sequence. Determining whether a key entry was an intentional entry, therefore, may be based on a comparison of the key sequence with a set of allowed key sequences. If the entered key sequence is an allowed key sequence, then the keyboard may be unlocked. Preferably, the set of allowed key sequences may include key sequences associated with usual user operations. Usual user operations may include entries of command sequences for the mobile telephone or entries of telephone numbers as normally entered in the course of using the mobile telephone.

In yet another preferred embodiment, unintended input operations may be avoided by unlocking a subset of keys of the keyboard. A group of unintended key entries may be further excluded when the subset of unlocked keys of the keyboard allows next key entries that include keyboard commands or telephone numbers according to the rules for entering valid telephone numbers. Advantageously, a plurality of associated subsets of next key entries for a plurality of key entries may be stored in the mobile telephone.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates an elevated front view of an embodiment of a mobile telephone constructed according to the principles of the present invention.

### DETAILED DESCRIPTION

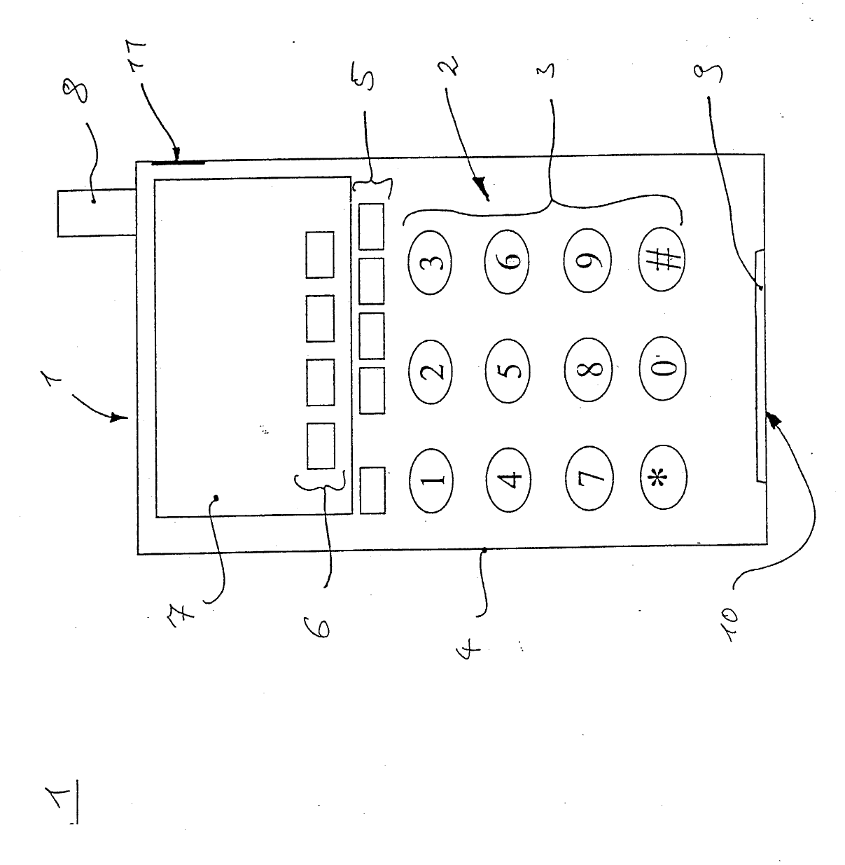

Referring initially to FIG. 1, illustrated is an elevated front view of an embodiment of a mobile telephone, generally designated 1, constructed according to the principles of the present invention. The mobile telephone 100 is a preferred embodiment of an electronic device employing the functionality of the present invention.

The mobile telephone 1 includes a keyboard 2, a housing 4, a first linear keypad array 5, a second linear keypad array 6, a display 7, an antenna 8, an input/output connector 9 and an infrared communications unit 11. The keyboard 2 includes a plurality of keys 3 as part of a front side of the housing 4. The first linear keypad array 5 and the second linear keypad array 6 include a plurality of keypads that are also located at the front side of the housing 4 and associated with specific command entries of the mobile telephone 1.

The display 7 shows graphical representations of input operations or messages of the mobile telephone 1. The antenna 8 is located on top of the housing 4 and the input/output connector 9 is part of a bottom portion 10 of the housing 4. The infrared communications unit 11 is located in an upper portion of the housing 4 in the neighborhood of the display 7. The housing 4, the display 7, the antenna 8, the input/output connector 9, the bottom portion 10 and the infrared communications unit 11 may be standard components of a conventional mobile telephone.

In one embodiment, the keyboard 2, the first linear keypad array 5 and the second linear keypad array 6 may be configured to be locked after a certain interval of time during which no entry is made. In some embodiments, the entry may be either intentional, unintended or both. Additionally, the keyboard 2, the first linear keypad array 5 and the second linear keypad array 6 may be configured to remain locked until unlocked via an unlock system by an entered sequence of intentional key entries.

The present invention provides a variety of detection and decision criteria for deciding when a key entry was an intentional entry. Accordingly, the term “a sequence of intentional key entries” shall also include a single key entry if the single key entry fulfills the necessary prerequisites for deciding that an intentional entry was made.

In a first preferred embodiment, an intentional key entry is made if a key was pressed for a first certain amount of time and released for a second certain amount of time. Typically, a time limit for pressing a key is within the range of 0-500 ms. Additionally, a time limit for releasing a key is also within the range of 0-500 ms. If a determination is made that an entry was an intentional key entry, then at least a portion of the keyboard 2 may be unlocked. Of course, one skilled in the art will understand that the entire keyboard 2 along with the first and second linear keypad array 5, 6, or a subset thereof, may be unlocked. If so, a user's input operations made via the keyboard 2, the plurality of keys 3, the first linear keypad array 5 or the second linear keypad array 6 may be accepted as valid user input operations.

In another preferred embodiment, the keyboard 2, the first linear keypad array 5 and the second linear keypad array 6 may be configured to remain locked until unlocked by a defined number of key entries within respective predefined time limits for pressing and releasing keys. The defined number of key entries may include a first key entry made within a respective predefined time limit and subsequent key entries each entered within the predefined time limit. The time limits for pressing down the key and for releasing the key may be between 0-500 ms. The number of defined key entries may have a minimum of four (4) but typically include six (6) to ten (10) entries.

In another embodiment, intentional key entries are determined by entering a number of key entries within a certain maximum time limit. If the time needed to enter the keys does not exceed the certain amount of time, the entries are deemed to be intentional key entries. According to this embodiment, six (6) key entries, for example, within a time interval of six (6) to ten (10) seconds may be used to indicate that intentional key entries were made.

In other embodiments, a decision whether key entries are intentional key entries may be based on a comparison of a sequence of the entered keys with a set of allowed key sequences. If the entered key sequence is deemed an allowed key sequence, at least a portion of the keyboard 2 may be unlocked. According to the present invention, an allowed key sequence may be a key sequence which during normal operation of the mobile telephone 1 may be used by an ordinary user in a valid manner. These allowed key sequences may be associated with user operations such as, for instance, an entry of a command sequence for the mobile telephone 1 or entries of a telephone number.

A test may be made as to whether the entered telephone number is entered according to existing rules for telephone numbers. In a most preferred embodiment, the test may include determining whether the entered key sequence comprises a leading “0” or a leading “+”. A command sequence may include, for example, starting a game, searching a telephone number stored in the mobile telephone 1 or entering configuration commands for the mobile telephone 1. Examples of the configuration commands may include but not limited to adjusting brightness or contrast of the display 7 or choosing a tone sequence for ring indication.

In a further preferred embodiment, a portion of the keyboard 2 may include a subset of the plurality of keys 3 of the keyboard 2 that may be unlocked upon deciding that an intentional entry was made. The subset of unlocked keys of the keyboard 2 may include allowed next key entries which are key entries that may be entered during a normal operation of the mobile telephone 1. A non-allowed key entry may be a senseless or wrong key entry that would not contribute to a normal operation of the mobile telephone 1. A senseless or wrong key may remain locked. Regarding command sequences, a senseless or wrong key may include all of the keys of the plurality of keys 3 which are not part of a command menu structure stored within the mobile telephone 1. Regarding telephone numbers, keys of the first and second linear keypad arrays 5, 6, may be considered senseless or wrong keys.

A preferred allowed subset of key entries which may be allowed during a locked condition of the keyboard 2 may include keys for establishing an emergency call. For example, numeral keys “9” and “1” of the plurality of keys 3 may be unlocked when pressed in a sequence “911.” Additionally, numeral keys “0”, “1” and “2” may establish an emergency call when pressed in a sequence “110” or “112” even when the keyboard 2 is in the locked condition.

Although the present invention has been described in detail, those skilled in the art should understand that they can make various changes, substitutions and alterations herein without departing from the spirit and scope of the invention in its broadest form.

What is claimed is:

1. An electronic device including a keyboard with a plurality of keys and having a key lock function that, when activated, locks said keyboard against unintended input operations,
said keyboard being apt to be unlocked, said electronic device, comprising:
an unlock system that allows at least a portion of said keyboard to be unlocked by entering a sequence of intentional key entries.

2. The electronic device as recited in claim 1 wherein said sequence of intentional key entries is determined based on whether a first key entry and subsequent key entries are each entered within predefined time limits for pressing and releasing keys, and a predefined number of said subsequent key entries are entered within a predefined interval of time after said first key entry.

3. The electronic device as recited in claim 1 wherein said electronic device stores pressing and releasing times of a number of key entries during a certain interval of time and accepts subsequent key entries as valid input operations if said subsequent key entries are within said pressing and releasing times.

4. The electronic device as recited in claim 1 wherein said sequence of intentional key entries is determined based on time limits for entering a key and a sequence of keys.

5. The electronic device as recited in claim 1 wherein said sequence of intentional key entries is determined based on a comparison of an entered key sequence with a set of allowed key sequences.

6. The electronic device as recited in claim 5 wherein said set of allowed key sequences includes key sequences associated with user operations selected from the group consisting of:
command sequences, and
telephone numbers.

7. The electronic device as recited in claim 6 wherein said command sequences include key entries for a special functionality of a mobile telephone selected from the group consisting of:
starting a game,
searching for a stored telephone number, and
entering configuration commands.

8. The electronic device as recited in claim 7 wherein said telephone numbers are tested based on existing rules for entering telephone numbers.

9. The electronic device as recited in claim 1 wherein said at least a portion includes a subset of keys of said plurality of keys, said subset of keys including allowed next key entries selected from a group consisting of:
next key entries of commands of said keyboard, and
next key entries of telephone numbers according to rules for entering valid telephone numbers.

10. The electronic device as recited in claim 1 wherein said key lock function is automatically activated after no key entry is made for a predefined period of time.

11. A method of unlocking a keyboard associated with an electronic device, comprising:
entering at least one key;
determining if said entered key is a sequence of intentional key entries; and
unlocking at least a portion of said keyboard if said entered key is a sequence of intentional key entries.

12. The method as recited in claim 11 wherein said sequence of intentional key entries is determined based on whether a first key entry and subsequent key entries are each entered within predefined time limits for pressing and releasing keys, and a predefined number of said subsequent key entries are entered within a predefined interval of time after said first key entry.

13. The method as recited in claim 11, further comprising:
storing pressing and releasing times of a number of key entries during a certain interval of time; and
accepting subsequent key entries as valid input operations if said subsequent key entries are within said pressing and releasing times.

14. The method as recited in claim 11 wherein said sequence of intentional key entries is determined based on time limits for entering a key and a sequence of keys.

15. The method as recited in claim 11 wherein said sequence of intentional key entries is determined based on a comparison of an entered key sequence with a set of allowed key sequences.

16. The method as recited in claim 15 wherein said set of allowed key sequences includes key sequences associated with user operations selected from the group consisting of:
command sequences, and
telephone numbers.

17. The method as recited in claim 16 wherein said command sequences include key entries for a special functionality of a mobile telephone selected from the group consisting of:
starting a game,
searching for a stored telephone number, and
entering configuration commands.

18. The method as recited in claim 17 wherein said telephone numbers are tested based on existing rules for entering telephone numbers.

19. The method as recited in claim 11 wherein said at least a portion includes a subset of keys of said plurality of keys, said subset of keys including allowed next key entries selected from a group consisting of:
next key entries of commands of said keyboard, and
next key entries of telephone numbers according to rules for entering valid telephone numbers.

20. The method as recited in claim 11 wherein said key lock function is automatically activated after no key entry is made for a predefined period of time.
